(19) United States
(12) Patent Application Publication
(10) Pub. No.: US 2006/0231550 A1
(43) Pub. Date: Oct. 19, 2006

(54) Product guidance system for continuous conveyor microwave oven

(76) Inventors: Thomas D. Wendel, Nashua, NH (US); E. Eugene Eves II, Westford, MA (US); Bruce Secovich, Hudson, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/335,837

(22) Filed: Jan. 19, 2006

Related U.S. Application Data
(60) Provisional application No. 60/645,376, filed on Jan. 20, 2005.

(51) Int. Cl. H05B 6/78

(52) U.S. Cl. 219/700; 219/762

(57) ABSTRACT

A constraint mechanism for holding products as they are processed through a microwave applicator, used specifically for constraining products as they travel on one or more continuous conveyors.

### RELATED APPLICATION

This application claims the benefit of U.S. Provisional Application No. 60/645,376, filed Jan. 20, 2005. The entire teachings of the above application are incorporated herein by reference.

### BACKGROUND OF THE INVENTION

The present invention relates to conveyors for use in microwave processing, and in particular to a constraint mechanism for holding conveyed items in place.

Volume processing of products with microwave energy, such as needed for large scale cooking, sterilization, and the like, typically uses a transmission system in which the microwave energy and the product being processed travel together through a waveguide applicator.

Many different approaches have been tried to improve the uniformity of results in such systems. These usually involve carefully designing the shape of the waveguide applicator.

In such systems, it also is typically desirable to process as many articles in as short a time as possible. Thus, it is common to process items while a continuous conveyor belt transports them through the applicator. Conveyor belts suitable for use in such environments are well known. For example, materials such as Teflon™ coated Kevlar™ or fiberglass are typically used for the conveyor belt.

### SUMMARY OF THE INVENTION

In addition to ensuring that the microwave applicator is properly dimensioned, it is also important to ensure that the position of the product with respect to the waveguide is carefully controlled. There is no advantage to having a precisely dimensioned applicator, if consistent positioning of the product within the applicator cannot be assured as it travels down the conveyor. If a product moves up and down, or from side to side, while being conveyed through applicator, uneven results will occur.

The present invention is a mechanism for constraining the location of a product (“or other package”) as it moves on a conveyor through a microwave applicator. In one preferred embodiment, the constraint is provided by one or more strings made of a polymer that is transparent to microwave energy. The portion of the constraint mechanism located in the applicator section is ideally limited to including essentially the polymer strings, in order to avoid introducing undesirable interactions with the microwave energy.

The strings are made of a suitable material that is temperature, fluid and microwave insensitive. Nylon, Teflon™ and Kevlar™ are examples of suitable materials. Polypropylene and polyethylene are probably not suitable.

Tensioning is preferably applied to the strings to hold the product in place, such as via one or more springs. Tension measurement devices, such as motion transducers, may also be used in combination with the tensioning devices to provide feedback on the package location and condition. The tensioning and tension measurement devices can be located outside the active area of the applicator.

Movement of the strings, as detected by the transducers, may be symptomatic of a fault condition, such that the product is improperly positioned on the conveyor, or other problems.

In an alternate embodiment of the basic concept, leaf springs can be used as tensioners. The leaf springs not only hold the strings under tension, but they may have perforations formed therein. If so, the perforations provide improved heat transfer in a fluid-filled applicator.

The constraint mechanism is placed in close proximity to the conveyor. For example, constraints are typically positioned both above and below the upper and lower conveyors in a fluid-filled applicator.

However advantages are provided even when a single conveyor is used for processing product, such as an air-filled applicator, where the constraint mechanism is present on only the bottom.

It should be understood that as long as the support structure is capable of assisting with constraining the products in position on the conveyor, the exact form of the constraint and the materials chosen may vary. Thus implementations of the invention are possible beyond those explicitly shown and described herein.

There are several benefits provided by a conveyor product guidance system according to the present invention.

The constraining mechanism maintains the location of product packages while they travel through a microwave applicator on a conveyor. This improves uniformity of microwave processing.

In environments where products also travel through water, vegetable oil, or other fluids while being processed, turbulence is introduced or increased by the constraints, thereby improving mixing and heat transfer.

Furthermore, movement of the constraints can be detected by a transducer, which provides feedback on the location and condition of the packages. This can be particularly advantageous in detecting malfunctions, such as when a package may have become swollen or blocked during processing.

Much of the constraint structure can be located outside of the applicator so that it does not interfere with uniform application of microwaves. This also helps ensure that microwave energy does not interfere with the transducers used to determine string deflection.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a isometric view of a microwave applicator using a product constraint mechanism according to one embodiment of the invention, for use in a fluid-filled applicator.

FIG. 2 is a view similar to that of FIG. 1, with conveyor belts removed for clarity.

FIGS. 3A, 3B and 3C show respective isometric, cross sectional longitudinal, and cross sectional lateral views of the same embodiment.

FIG. 4 is a schematic illustration useful for understanding the function of the springs and position detectors.

FIG. 5 is a isometric view of an alternate embodiment of the invention for an air-filled applicator.

FIGS. 6A, 6B and 6C are isometric, longitudinal cross section, and lateral cross sectional views of an alternative embodiment of the invention which uses leaf springs to provide tension.

FIG. 7 is a partially cut away isometric view of the embodiment of FIG. 6.

FIG. 8 is a another view of the same embodiment with a top support plate removed for clarity.

FIG. 9 is a view of a similar embodiment used when products are processed in an air-filled applicator.

FIG. 10 is a view similar to FIG. 9, but showing a conveyor belt installed.

### DETAILED DESCRIPTION OF THE INVENTION

A description of preferred embodiments of the invention follows.

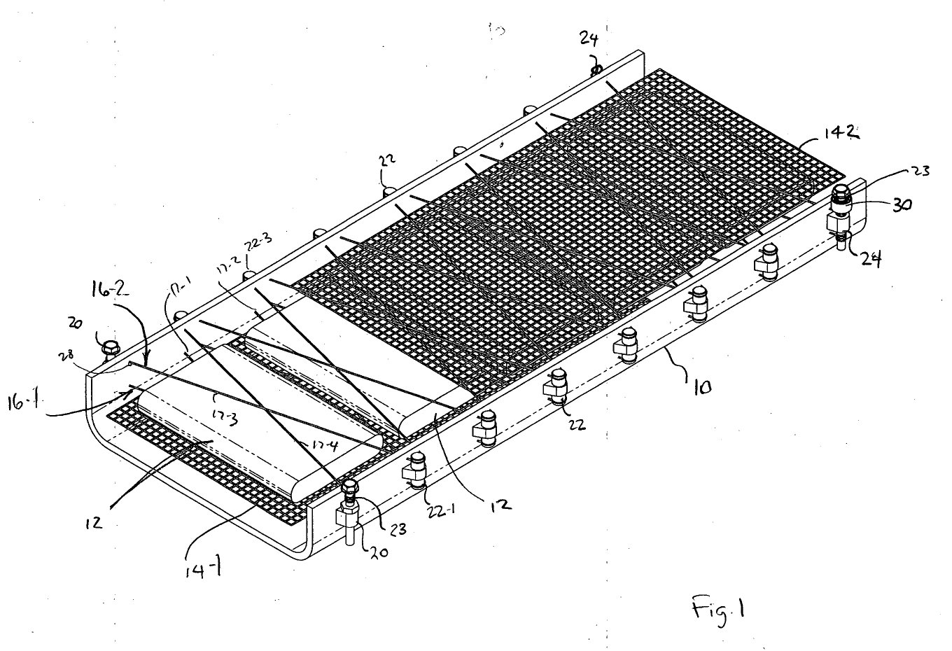

FIG. 1 illustrates one embodiment of a continuous feed microwave applicator 10 that uses a product constraint mechanism according to the invention. The applicator 10 may be generally rectangular in cross section. In the drawings herein, a top portion or cover of the applicator 10 has been removed, and is not shown, so that the products 12 and internal components can be seen more readily.

The applicator 10 may be “fluid filled” or “air filled”. It should be understood that the fluids used might be water, vegetable oil, or other fluids. In general, when we refer to “fluid environments” herein, the fluid is typically the same density as the products 12 being processed. Reference to an “air filled” applicator 10 herein includes environments not only where the product is processed in air, but also wherever the product 12 substantially more dense than the surrounding fluid.

Within the applicator 10 travel products 12 to be processed by microwaves, such as for heating, cooking, browning, sterilizing, drying, or a combination thereof. The products 12 may be meats, or other foods packaged into “pouches”, or other objects. The products 12 are carried by one or more conveyor belts 14-1, 14-2. A lower conveyor belt 14-1 and upper conveyor belt 14-2 (collectively, the conveyor 14) are used, for example, to process products 12 where the applicator 10 is filled with water, vegetable oil, or other fluid. Such may be the case, for example, in sterilization processing or browning of products 12.

A guidance or constraint mechanism 16-1, 16-2 (collectively the constraints 16) is located in proximity to the products 12. The constraint mechanism 16 maintains the position of products 12 as they travel through the applicator 10, preferably along at least one axis transverse to the direction of travel of the conveyor (s) 14

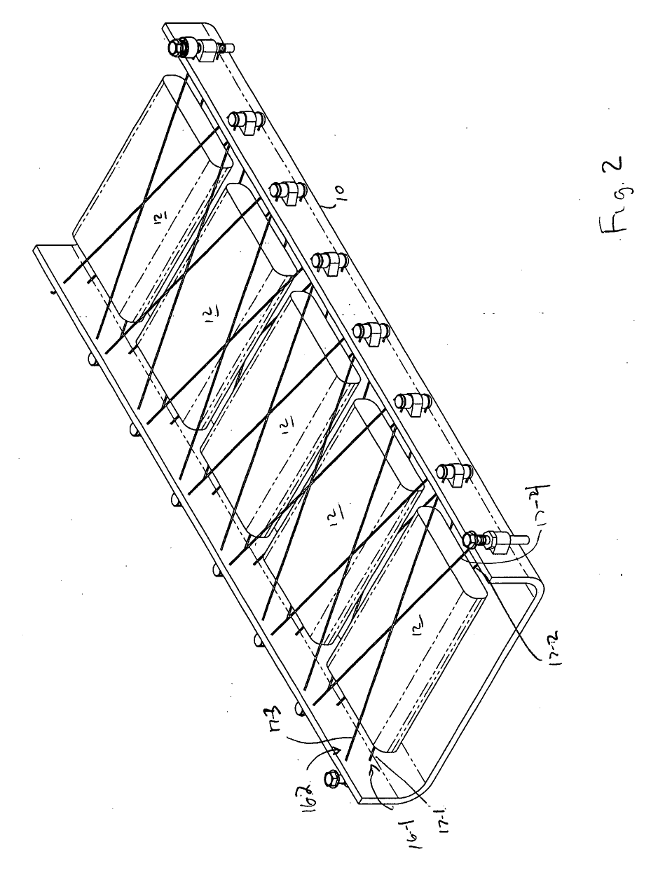

As best seen in FIG. 2, in a preferred arrangement, the constraints are provided by sets of strings. A lower constraint 16-1 consists of lower strings 17-1,17-2 and an upper constraint 16-1 consists of upper strings 17-3,17-4.

The strings 17 are placed outboard of a respective one of the conveyors 14. Thus, for example, lower support 16-1 including lower strings 17-1,17-2 is positioned beneath the lower conveyor 14-1, and upper support 16-2 including upper strings 17-3,17-4 is placed above the upper conveyor 14-2. The strings 17 are held under tension to control the location of products 12 as they move through applicator 10. The strings, in effect, constrain the “staging”, “bulging”, or other movement of the conveyor 14, which would otherwise cause the transverse position of products 12 to change with respect to the applicator 10. For example, if the conveyor 14 were otherwise allowed to sag in the middle as it traverses applicator 10, the products would move up and down with respect to applicator 10.

Conveyors 14 in one embodiment can be a belt formed of substantially microwave transparent polymer material. The belts can be formed from Nylon, Nomex™ or preferably Kevlar™, Kevlar™ being a specific aramid (aromatic polyamide) fiber which is microwave-inert, substantially heat resistant up to 400° F. or higher. Kevlar™ can be mixed with Teflon™ or other suitable materials to prevent the articles 12 from sticking. ULTEM™ resin, a product manufactured by GE Plastics and sold under therein trademarked brand, is one other suitable polyethermide material. The conveyor belts 14 can be made as a mesh, and are driven by mechanisms not shown in the drawings herein.

The strings 17 are of relatively small diameter such that they do not interfere with the development of a uniform microwave heating pattern throughout the applicator 10. Strings 17 are made of a material that is relatively temperature, fluid and microwave insensitive, such as Nylon, Teflon™ and Kevlar™.

The strings 17 perform the desired product guidance function by cooperating with additional elements. These may include supports 20, 22, 24 positioned along the length of the applicator 10. In the illustrated embodiment, for example, first upper string 17-1 is attached to a first support 20 on one side of the applicator 10. String 17-1 is then fed across the body of the applicator 10 through a small hole 28 formed in the side thereof to a support 22-1 on an opposite side thereof. The string 17-3 then travels back through another hole 28 through the applicator to a support 22-3 on the rear side. A second upper string 17-4 also forming a portion of the upper restraint 16-2 travels similarly along the applicator 10 between supports 22 but in an opposing criss-cross fashion.

A similar constraint arrangement 16-1 is present on the bottom of the applicator, to support the lower conveyor 14-1, using lower criss-crossing strings 17-1 and 17-2.

Certain ones of the support posts 20, such as an end post 24 may have spring tensioners 23 that provide spring tension to the string 17-3. The intermediate posts 22 may also provide further spring tension. The final post 24 may, in addition to having a tensioner 23, provide feedback on movement of the strings 17. In particular, post 24 may include a position sensor transducer 30 which can be used to detect relative movement of the string 17-3.

Strings 17-1, 17-2, and 17-4 are similarly arranged with supports 20, 22 and/or 24.

FIG. 2 is a view similar to that of FIG. 1 but with the conveyors 14 removed for clarity. Here it is more readily seen that upper constraint 16-2 consists of a first string 17-3 which criss-crosses through the applicator 10 interior and a second string 17-4 that criss-crosses in a complementary fashion.

Similarly, the lower constraint 16-1 makes use of a pair of strings 17-1, 17-2 that also criss-cross through the interior of applicator 10.

Although the strings 17 are shown to be diagonally criss-crossing the interior of the applicator 10, they could also be strung straight across, or in other ways.

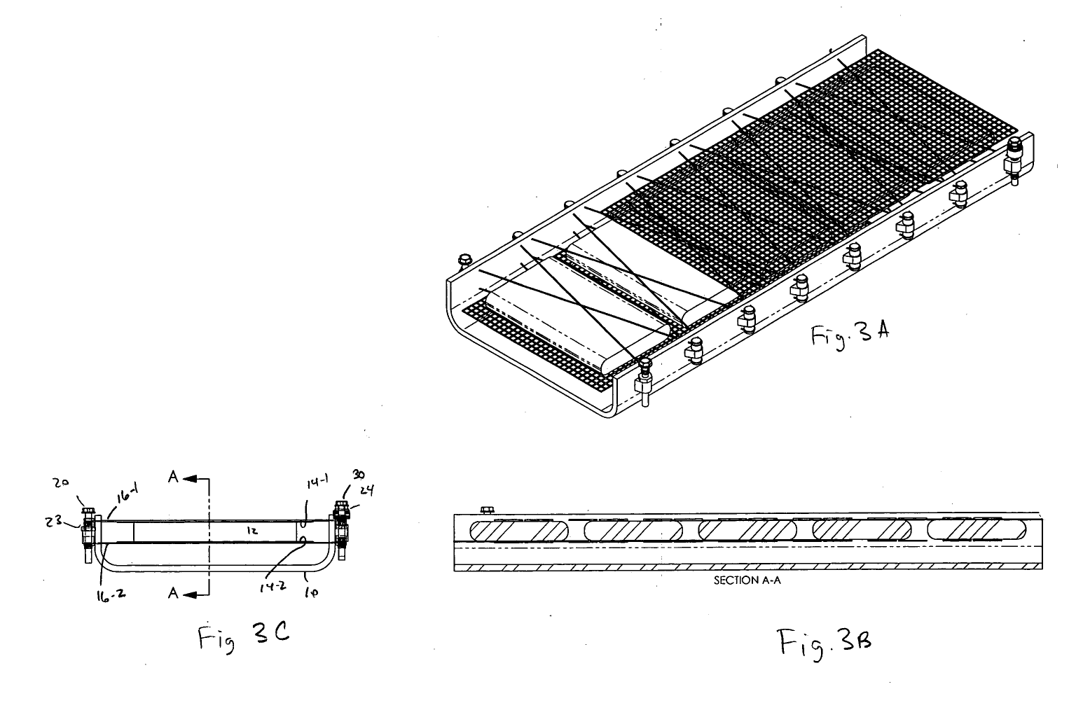

FIGS. 3A, 3B and 3C show an isometric, a cross sectional longitudinal, and cross sectional lateral views of the applicator 10 and constraint mechanisms 16. FIG. 3C specifically shows the relative positions of the applicator 10, product 12, upper conveyor 14-1, upper conveyor 14-2 and lower constraint 16-1 and upper constraint 16-2.

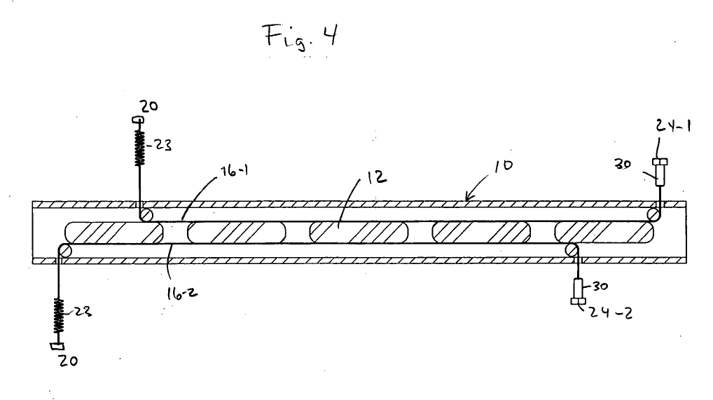

FIG. 4 is a schematic diagram showing the relative location of posts 20 having spring tensioners 23, constraints 16, and posts 24 having position sensors 30. In normal operation, where products 12 are of uniform thickness and/or shape, strings 16 provides a constant tension force from spring 23 to the position sensor 24. However, whenever a product 12 of abnormal shape, either thicker or thinner than normal, is present in the applicator 10, the amount of spring tension will be correspondingly reduced or increased and detected by one or more of the position sensors 24.

Electronic circuits (not shown) receive signals indicative of changes in tension in both the lower constraint 16-1 and the upper constraint 16-2, via feedback provided by respective position sensors 24-1, 24-2. These signals can then be used as an indication of the location and condition of the packages 12, which in turn may indicate that a package has been improperly processed and/or a system malfunction.

It can now also be understood how the springs 23 and detector 20 are located outside of the microwave applicator 10. This provides additional advantages in that microwave energy traveling through the applicator 10 is not perturbed by the presence of springs 23 or position sensor 30. Similarly, microwave energy itself does not interfere with operation of measurement of the spring deflection by the position sensor 30 which might otherwise occur if the position sensor 30 were located within the waveguide 10.

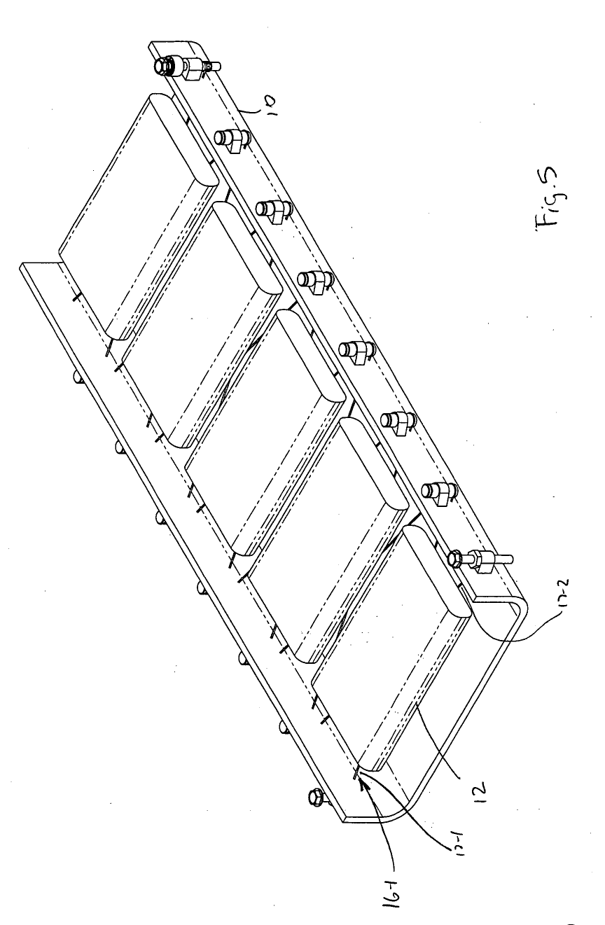

FIG. 5 is a view of an alternate embodiment of the invention. In this implementation (conveyor 14 is not shown here for clarity), the products 12 are processed in a air-filled applicator 10. Thus, they need only be constrained in one direction (the lower direction). Thus only the lower constraint 16-1 need be present. In this embodiment lower constraint 16-1 essentially support the conveyor 14-1 (not shown in FIG. 5 from sagging under the weight of products 12.

In other instances, when the product 12 is substantially less dense than the surrounding fluid, only an upper conveyor 14-2 is needed, instead of a single lower conveyor 14-1.

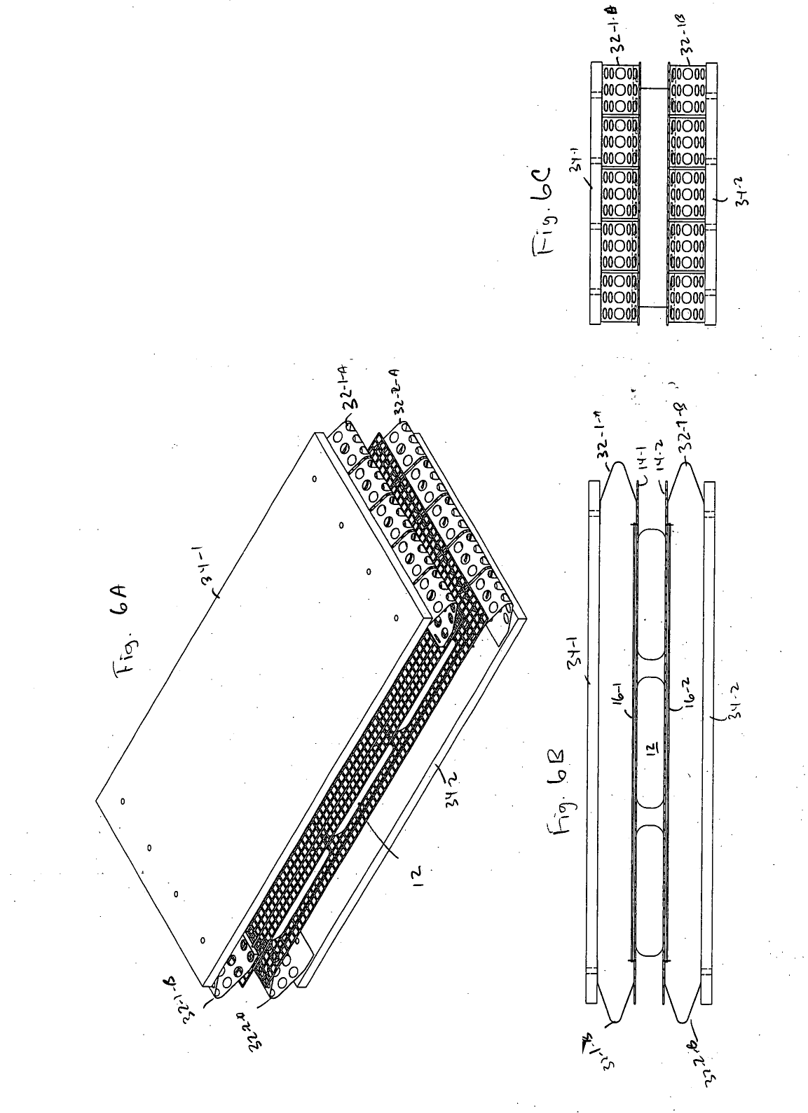

FIGS. 6A, 6B and 6C show isometric, cross sectional longitudinal, and cross sectional lateral views of an alternate embodiment of the invention. In this implementation, tension is provided to the strings 17 via a leaf spring arrangement. As shown, a set of leaf springs 32-1, 32-2A, 32-2B are used on respectively the top and bottom portions of supports 34-1, 34-2. The supports 34-1, 34-2 may be an integral portion of the microwave applicator 10 or may be placed within. The strings 17 here may be strung straight across from one leaf spring to the other.

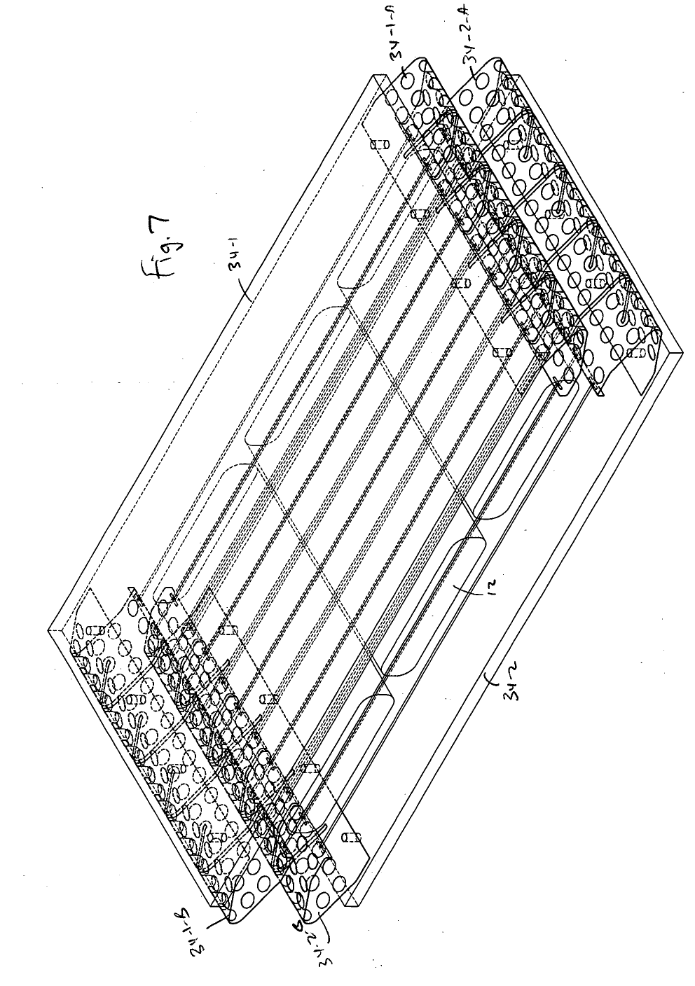

FIG. 7 shows a more detailed isometric view with the top plate shown in ghosted form and with the conveyor belts 14 removed.

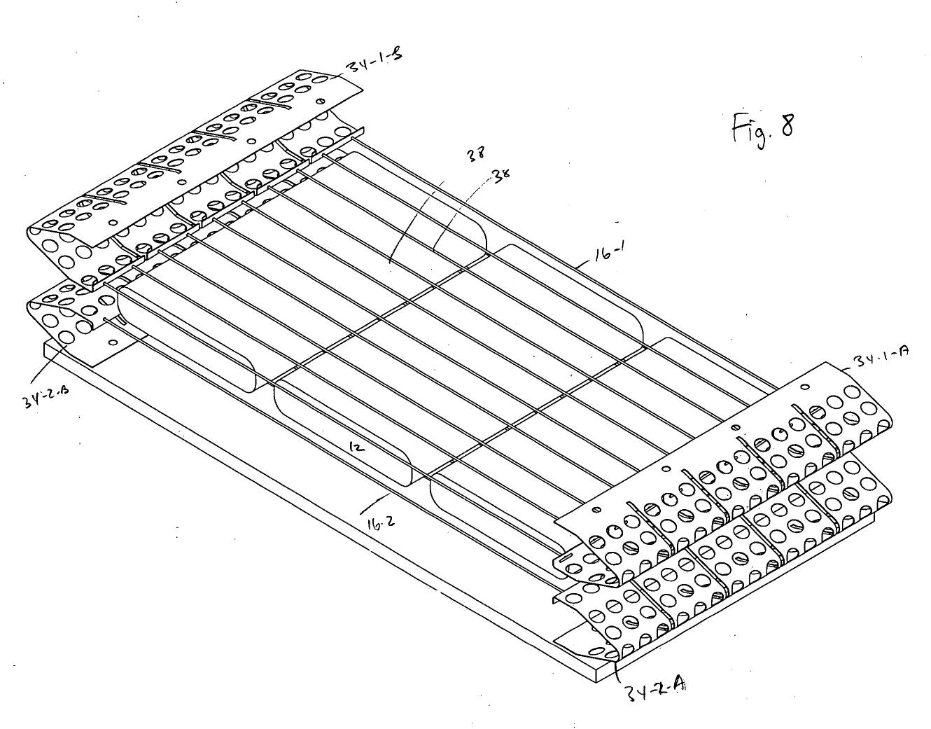

FIG. 8 is a similar isometric view showing more detail of the leaf springs 34-1-A, 34-1-B with the strings 17 shown in more detail. Here an upper string section consists of a series of strings 38 extended across the springs 34-1-A, 34-1-B. A similar arrangement is provided on the bottom of product “pouches” 12 by leaf springs 34-2-A, 34-2-B.

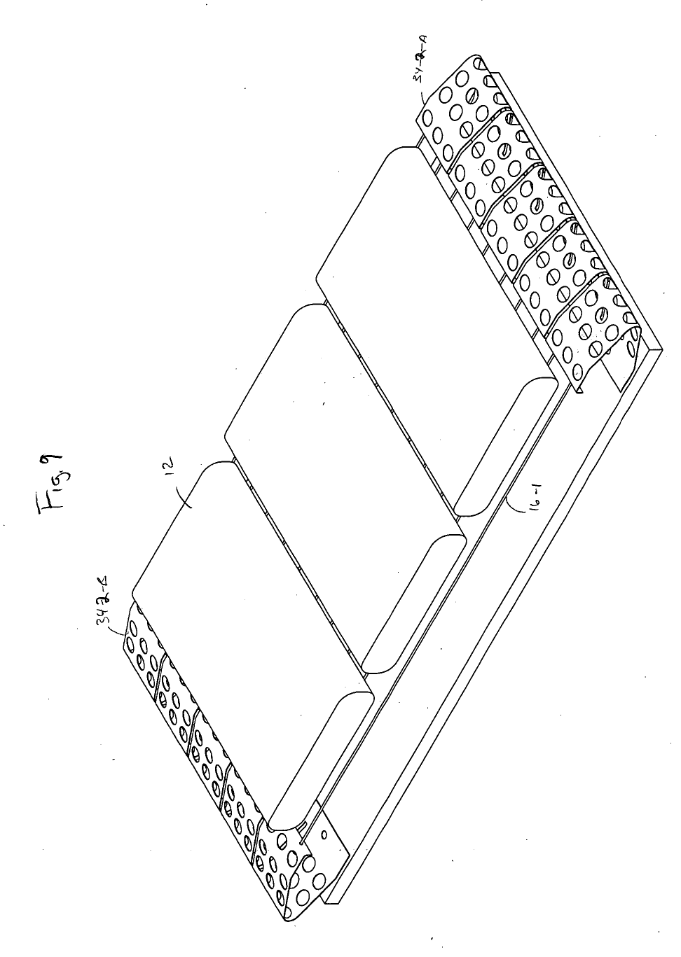

An arrangement can also be provided using leaf springs as shown in FIG. 9 where air is utilized in the applicator 10. In this instance, no upper restraint 34-1 is required.

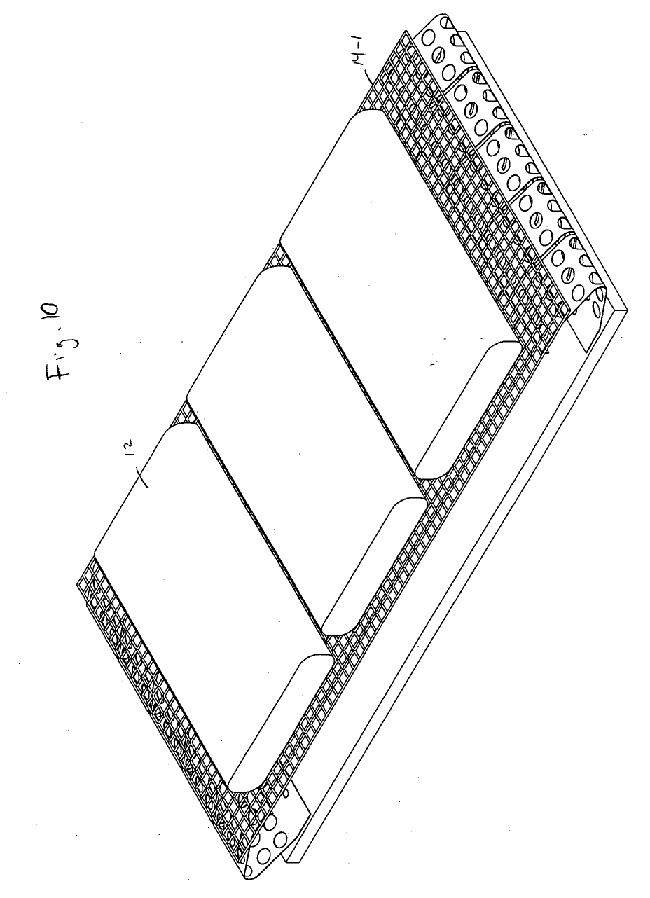

Finally, FIG. 10 is a view similar to that of FIG. 9 but with the conveyor belt shown. In the embodiments using leaf springs 34 to tension the string 16, other mechanisms (not shown) may be used for determining the amount of deflection of the strings such as may be attached to the top of leaf springs 34 to measure their movement.

In the air-filled applicator 10 implementations of FIGS. 5, 9 and 10, the wires 17 serve to principally support the conveyor 14. Providing support of the conveyor 14 along a relatively long length of applicator 10 can itself provide improved positioning of the product.

The invention also of course provides the aforementioned advantages in water-filled applicators 10 where the product 12 may otherwise float and move both up and down but also side to side while traveling with the conveyors 14.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus comprising:
a microwave energy applicator;
a conveyor, arranged to move products through the microwave application; and
a constraint for holding products in position adjacent the conveyor while such products travel through a the applicator.

2. An apparatus as in claim 1 wherein the constraint further comprises strings held under tension.

3. An apparatus as in claim 2 wherein a detector determines an amount of tension on the strings.

4. An apparatus as in claim 1 wherein the conveyor comprises both an upper conveyor and a lower conveyor.

5. An apparatus as in claims 4 where the constraint holds products against both the upper and lower conveyor.

6. An apparatus as in claim 1 wherein the constraint further encompasses a folded leaf spring arranged to hold one or more retaining strings.
